(19) United States
(12) Patent Application Publication
(10) Pub. No.: US 2006/0251889 A1
(43) Pub. Date: Nov. 9, 2006

(54) Pressure sensitive adhesive (PSA) laminates

(76) Inventors: Richard Lane, Voorschoten (NL); Derek William Bamborough, Nieuw en Sint Joosland (NL); Roelof Jacob Luth, Middelburg (NL); Daniel W. Klosiewicz, Kingsport, TN (US)

Correspondence Address: Polly C. Owen;Eastman Chemical Company, P.O. Box 511, Kingsport, TN, 37662-5075, US

(21) Appl. No.: 11/178,849

(22) Filed: Jul. 11, 2005

Related U.S. Application Data
(60) Provisional application No. 60/678,620, filed on May 6, 2005.

(51) Int. Cl. B32B 7/12

(52) U.S. Cl. 428/343; 428/354

(57) ABSTRACT

A PSA laminate is provided comprising: a) at least one outer filmic layer (A) comprising at least one filmic polymer; b) at least one adhesive base layer (B) comprising at least one adhesive base polymer; and c) at least one tackifier layer (C) comprising at least one tackifier; wherein the pressure sensitive adhesive laminate is obtainable by co-extruding the outer filmic layer (A) with the adhesive base layer (B) to produce a non-adhesive laminate and applying the tackifier layer (C) to the non-adhesive laminate to produce the PSA laminate.

### Cross Reference To Related Applications

This application claims the benefit of U.S. Provisional Application Ser. No. 60/678,620 entitled “Pressure Sensitive Adhesive (PSA) Laminates” filed on May 6th, 2005.

### FIELD OF INVENTION

The present invention relates to co-extruded non-adhesive laminates and pressure sensitive adhesive (PSA) laminates. The present invention also relates to processes for producing the non-adhesive laminates and PSA laminates. Articles of manufacture are also provided including, but not limited to, tapes, labels, protective films, signs, decals, and the like.

### BACKGROUND OF THE INVENTION

Generally, pressure sensitive adhesive laminates comprise at least one polymeric component, at least one tackifier component, and at least one plasticizer. These components are then physically mixed together using heat, water, or solvents. These pressure-sensitive adhesive (PSA) laminates are used in such articles of manufacture for example as labels, tapes, decals, signs, and the like. PSA labels are commonly used to apply printed information to an object or article. PSA labels typically comprise a release liner, a PSA layer disposed onto the release liner, and an outer layer which may be a filmic polymer laminated onto the PSA layer. Such laminates may be formed by first coating or laminating the PSA to the release liner, then laminating the outer layer onto the PSA-coated liner; or alternatively by coating or laminating the PSA to the outer layer, then the PSA-coated outer layer onto the release liner. The outer layer is typically made of plastic, which is printed on with information or other indicia either before or after the outer layer is laminated to the PSA and liner.

There are research efforts in the industry to improve the adhesive properties of PSA laminates and the processes for producing such laminates. Coextrusion has been utilized to coextrude the outer filmic layer and the pressure sensitive adhesive, however, processing problems have occurred, such as, adherence to equipment rollers. To prevent the PSA laminate from sticking to the equipment rollers, a release liner can be required which is laminated to the PSA laminate immediately after the co-extrusion process.

There is a need in the industry for improved processes for producing PSA laminates as well as laminates with improved properties.

### SUMMARY OF THE INVENTION

In accordance with one embodiment of this invention, a PSA laminate is provided comprising:
a. at least one outer filmic layer (A) comprising at least one filmic polymer;
b. at least one adhesive base layer (B) comprising at least one adhesive base polymer; and
c. at least one tackifier layer (C) comprising at least one tackifier;
wherein the pressure sensitive adhesive laminate is obtainable by co-extruding the outer filmic layer (A) with the adhesive base layer (B) to produce a non-adhesive laminate and applying the tackifier layer (C) to the non-adhesive laminate to produce the PSA laminate.
In accordance with another embodiment of this invention, a non-adhesive laminate is provided. The non-adhesive laminate comprising:
a. at least one outer filmic layer (A) comprising at least one filmic polymer; and
b. at least one adhesive base layer (B) comprising at least one adhesive base polymer; wherein the non-adhesive laminate is obtainable by co-extruding the outer filmic layer (A) with the adhesive base layer (B) comprising at least one adhesive base polymer to produce the non-adhesive laminate.

In accordance with another embodiment of this invention, a process to produce the non-adhesive laminate is provided. The process comprises co-extruding at least one outer filmic layer (A) comprising at least one filmic polymer and at least one adhesive base layer (B) comprising at least one adhesive base polymer to produce the non-adhesive laminate.

In accordance with another embodiment of this invention, a process to produce the PSA laminate is provided. The process comprises co-extruding at least one outer filmic layer (A) comprising at least one filmic polymer and at least one adhesive base layer (B) comprising at least one adhesive base polymer to produce the non-adhesive laminate and applying at least one tackifier layer (C) to the adhesive base layer of the non-adhesive laminate to produce the PSA laminate.

The present invention is based on the discovery that a non-adhesive laminate comprising at least one filmic outer layer (A) and at least one adhesive base layer (B) can be converted into a PSA laminate by applying at least one tackifier layer (C). It was found that by implementing this approach, a PSA laminate can be obtained with at least one of the following advantages over PSA laminates manufactured by conventional processes.

First, the adhesive base polymer of the adhesive base layer (B) is co-extruded onto the outer filmic layer (A) thus forming a bond (i.e. intra molecularly bonded) thereby improving the anchorage of the adhesive base polymer onto the outer filmic layer. This can eliminate any offsetting that can occur with a normally manufactured filmic label PSA. Offsetting is the undesirable transfer of adhesive to a substrate during label removal caused by insufficient anchorage of the adhesive onto the filmic label substrate. Furthermore, this implies that any bond of the PSA laminate with a substrate during use of the PSA laminate will fail at the substrate interface or internally, i.e. cohesive failure. The advantage of this type of failure is that it allows suitable formulations to be made to result in cohesive failing, tamper evident bonds suitable for security, tamper proof labeling; for adhesion, interface failure mode, removable PSA laminate applications; or for re-positioning and resealing applications.

Secondly, the tackifier layer (C) can be coated at very low temperatures, typically up to 100° C. lower than a traditional hot melt pressure sensitive adhesive, since it no longer contains the adhesive base polymer. This improves the filmic label manufacturing process in at least one of the following ways:
a. heat sensitive outer filmic layers, e.g. polyethylene, are not affected;
b. lower operating costs due to the lower coating temperature; and
c. the tackifier layer (C) has improved heat aging properties, less colour loss, no charring, etc. compared with a traditional hot melt pressure sensitive adhesive that require higher temperatures.

Another advantage is the the molecular weight gradient of tackifier in the adhesive base layer (B) and the tackifier layer (C). Athough not intending to be bound by theory, it is believed due to the mechanism of auto adhesion fusion and intramolecular migration, the adhesive base layer (B) and the tackifier layer (C) can exhibit a molecular weight gradient of tackifier from the tackifier layer (C) to the adhesive base layer (B). This molecular weight gradient leaves a low molecular weight, high tack layer at the surface of the tackifier layer (C) where this functionality is required to create pressure sensitive bonds. The migration of the tackifier into the adhesive base layer (B), the high molecular weight portion of the PSA laminate, can improve at least one of the following properties: shear resistance, creep resistance, and high temperature performance.

Another advantage of the present invention is the adhesive base layer (B) can be manufactured with high cohesive strength base-polymers. Using such high cohesive strength base-polymers to manufacture conventional hot melt pressure sensitive adhesives can result in very high hot melt viscosities, so high that they cannot be coated using known hot melt coating equipment.

Yet another advantage of this invention is that PSA laminates can now be assembled from readily available non-adhesive laminates which consist of the filmic outer layer (A) and the adhesive base layer (B) that can be converted into the PSA laminate by applying a tackifier layer (C) by normal coating techniques known to a person skilled in the art of coating adhesives (such as slot-die coating, curtain coating, spray coating or solution coating).

### BRIEF DESCRIPTION OF THE DRAWINGS

FIG. 1 is a cross-section of a pressure sensitive adhesive laminate in one embodiment of the invention having an outer filmic layer (A), adhesive base layer (B), and tackifier layer (C).

FIG. 2 is a cross-section of a pressure sensitive adhesive laminate in another embodiment of the invention having an outer filmic layer (A), adhesive base layer (B), tackifier layer (C), and release layer (D).

FIG. 3 is a cross-section of a pressure sensitive adhesive laminate in another embodiment of the invention having an outer filmic layer (A), adhesive base layer (B), tackifier layer (C), and overlaminate layer (E).

FIG. 4 is a cross-section of a pressure sensitive adhesive laminate in another embodiment of the invention having an outer filmic layer (A), adhesive base layer (B), tackifier layer (C), and barrier layer (F).

FIG. 5 is a cross-section of a pressure sensitive adhesive laminate in another embodiment of the invention having an outer filmic layer (A), adhesive base layer (B), tackifier layer (C), overlaminate layer (E), and barrier layer (F).

FIG. 6 is a cross-section of a pressure sensitive adhesive laminate in another embodiment of the invention having an outer filmic layer (A), adhesive base layer (B), tackifier layer (C), release layer (D), and overlaminate layer (E).

FIG. 7 is a cross-section of a pressure sensitive adhesive laminate in another embodiment of the invention having an outer filmic layer (A), adhesive base layer (B), tackifier layer (C), release layer (D), and barrier layer (F).

FIG. 8 is a cross-section of a pressure sensitive adhesive laminate in another embodiment of the invention having an outer filmic layer (A), adhesive base layer (B), tackifier layer (C), release layer (D), overlaminate layer (E), and barrier layer (F).

FIG. 9 is a schematic overview of one embodiment of a process for preparing the PSA laminate according to the present invention.

### DETAILED DESCRIPTION OF THE INVENTION

Before the present compositions of matter and methods are disclosed and described, it is to be understood that this invention is not limited to specific methods or to particular formulations, except as indicated, and as such, may vary from the disclosure. It is also to be understood that the terminology used is for the purpose of describing particular embodiments only, and is not intended to limit the scope of the invention.

The singular forms “a,” “an,” and “the” include plural referents, unless the context clearly dictates otherwise.

Optional or optionally means that the subsequently described event or circumstances may or may not occur. The description includes instances where the event or circumstance occurs, and instances where it does not occur.

Ranges may be expressed herein as from about one particular value, and/or to about another particular value. When such a range is expressed, it is to be understood that another embodiment is from the one particular value and/or to the other particular value, along with all combinations within said range.

Throughout this application, where patents or publications are referenced, the disclosures of these references in their entireties are intended to be incorporated by reference into this application, in order to more fully describe the state of the art to which the invention pertains.

The term “PSA” as used in this disclosure refers to an adhesive that will form a bond to two surfaces under light finger pressure at room temperature. The PSA provides enough potential deformability and wettability so that the necessary contact to a surface can be achieved, yet there is enough internal strength, or cohesion, within the adhesive for it to be able to resist any moderate separation forces. More information concerning the definition of a PSA can be found in Pressure Senstive Adhesive Tapes, A Guide to Their Function, Design, Manufacture, and Use, John Johnston, Pressure Sensitve Tape Council, 2000, Chap. 2, p. 23.

In an embodiment of this invention, a pressure sensitive adhesive (PSA) laminate is provided comprising: a) at least one outer filmic layer (A) comprising at least one filmic polymer; b) at least one adhesive base layer (B) comprising at least one adhesive base polymer; and c) at least one tackifier layer (C) comprising at least one tackifier; wherein the pressure sensitive adhesive laminate is obtainable by co-extruding the outer filmic layer (A) with the adhesive base layer (B) to produce a non-adhesive laminate and applying the tackifier layer (C) to produce the PSA laminate.

The outer filmic layer comprises at least one filmic polymer. In one embodiment of the invention, the outer filmic layer can contain a blend of filmic polymers or can be a multi-layer film of various filmic polymers. Filmic polymers include any filmic polymer that can be co-extruded with the adhesive base polymer to produce the non-adhesive laminate. In one embodiment of the invention, it may be desired that the filmic polymer has a solubility parameter that is inconsistent with or incompatible with that of the adhesive base polymer to prevent migration between the two layers.

In another embodiment of the invention, the filmic polymer can, when combined with the adhesive base polymer, provide a sufficiently self-supporting construction to facilitate label separation and application. Alternatively, when the filmic polymer combined with the adhesive base polymer is not sufficiently self-supporting, an overlaminate layer can be applied to the exposed face of the outer filmic layer to provide additional stiffness. Preferably, the filmic polymer and any other material utilized in the outer filmic layer are chosen to provide the non-adhesive laminate with the desired properties such as inter alia printability.

Typical filmic polymers include, but are not limited to, polystyrenes, polyolefins, polyamides, polyesters (e.g. polyethylene terephthalate), polycarbonates, polyurethanes, polyacrylates, polyvinyl alcohols, polyesters, functional polyesters (e.g. sulfopolyesters), poly(ethylene vinyl alcohols), polyether block polyamides, polyvinyl acetates, and mixtures thereof. Preferably, the filmic polymer is a polyolefin including, but not limited to, polymers having repeating units selected from the group consisting of ethylene, propylene, and 1-butene. Most preferably, the filmic polymer is at least one selected from the group consisting of polyethylene, polypropylene and ethylene-propylene copolymer. Various polyethylenes can be utilized including low, medium, and high density polyethylenes.

In one embodiment of the invention, the melt flow rate (MFR) of polyethylene used in the outer filmic layer can range from about 0.1 to about 15 g/10 minutes measured at 190° C. using a 2.16 kg weight, preferably from 0.1 to 5. A commercial example of a polyethylene useful as the outer filmic layer is low density polyethylene sold as Lupolen 2426F having a density of about 0.924 g/cm³ using ISO 1183 test method and a melt flow rate of about 0.75 g/10 minutes following test method ISO 1133 obtained from Basell Polyolefins located in The Netherlands.

In another embodiment of the invention, the melt flow rate (MFR) of polypropylene used in the outer filmic layer can range from about 1 to about 20 g/10 minutes measured at 230° C. using a 2.16 kg weight, preferably from 0.1 to 10. A commercial example of a polypropylene useful as the outer filmic layer is polypropylene homopolymer sold as Moplen HP422H having a density of 0.900 g/cm³ using ISO 1183 test method and a melt flow rate of about 2 g/10 minutes at 190° C. using a 2.16 kg weight following test method ISO 1133 obtained from Basell Polyolefins located in The Netherlands. A commercial example of a random polypropylene copolymer useful as the outer filmic layer is Moplen RP210M polypropylene having a density of 0.900 g/cm³ using ISO 1183 test method and a melt flow rate of about 6 g/10 minutes at 190° C. using a 2.16 kg weight following test method ISO 1133 obtained from Basell Polyolefins located in The Netherlands.

The inner surface of the outer filmic layer may be co-extruded with a barrier layer other than the barrier created by the adhesive base polymer layer (B) and/or the tackifier layer (C) of this invention. The barrier layer may prevent migration of constituents to the outer filmic layer. There may also be included, or alternatively provided, a tie or primer layer to enhance adhesion of the adhesive base polymer layer to the outer filmic layer. Moreover, “linerless” constructions are contemplated to be within the scope of the present claims. In linerless constructions the outer surface is coated with a release material, such as a silicone (e.g., polydimethylsiloxane).

Generally, the outer filmic layer has a thickness that is suitable for the particular PSA laminate application. In one embodiment of the invention, the outer filmic layer has a thickness of about 10 μm to about 200 μm, preferably from about 20 μm to about 100 μm, and most preferably, from 30 μm to 90 μm.

The adhesive base layer comprises at least one adhesive base polymer. The adhesive base polymer can be any that is known in the art that can be co-extruded with the outer filmic polymer and is suitable for producing a non-adhesive laminate or PSA laminate. Generally, the adhesive base polymer utilized to produce the non-adhesive laminate or PSA laminate may generally be classified into the following categories:

random copolymer adhesive base materials, such as, but not limited to, those copolymers based upon acrylate and/or methacrylate copolymers, α-olefin copolymers, silicone-copolymers, chloroprene/acrylonitrile copolymers, and the like;

block copolymer adhesive base polymers, such as, but are not limited to, those based upon linear block copolymers (e.g., A-B and A-B-A type), branched block copolymers, star block copolymers, grafted, or radial block copolymers, and the like; and

natural and synthetic rubber adhesive base polymers, such as, but are not limited to, polyisobutylene, polyisoprene, butyl rubber, and the like.

In another embodiment of the invention, the adhesive base polymer comprises a thermoplastic elastomer (TPE). TPEs include, but are not limited to, linear, branched, graft or radial block copolymers. Block copolymers can be represented by a di-block structure A-B, a tri-block A-B-A, a tetra-block structure, a higher block structures, a radial or coupled structure (A-B)ₙ, and combinations of these structure; wherein A represents a hard thermoplastic phase or block which is non-rubbery or glassy or crystalline at room temperature but fluid at high temperatures, and B represents a soft-block which is rubbery or elastomeric at service or room temperatures. These thermoplastic elastomers may comprise from about 75% to about 95% by weight of rubbery segments and from about 5% to about 25% by weight of non-rubbery segments.

The non-rubbery segments or hard blocks comprise polymers of mono- and poly-cyclic aromatic hydrocarbons, and more particularly vinyl-substituted aromatic hydrocarbons which may be mono-cyclic or bi-cyclic in nature. The preferred rubbery blocks or segments comprise polymer blocks of homopolymers or copolymers of aliphatic conjugated dienes. Rubbery materials, such as, but not limited to, polyisoprene, polybutadiene, and styrene butadiene rubbers may be used to form the rubbery block or segment. Particularly preferred rubbery segments include polydienes, unsaturated olefins rubbers of ethylene-butylene or ethylene-propylene copolymers. The latter rubbers may be obtained from the corresponding unsaturated polyalkylene moieties such as polybutadiene and polyisoprene by hydrogenation thereof.

In one embodiment of the invention, the block copolymer may be selected from the group consisting of butadiene-based polymers, isoprene-based polymers, polyether block polyamides, and mixtures thereof. Thus, the butadiene-based polymers may be selected from the group consisting of styrene-butadiene-styrene (SBS) block copolymers, styrene-butadiene (SB) block copolymers, multi-armed (SB)ₓ block copolymers, polybutadiene block copolymers, and mixtures thereof. Isoprene-based copolymers may be selected from the group consisting of styrene-isoprene-styrene (SIS) block copolymers, styrene-isoprene-butadiene-styrene (SIBS) copolymers, styrene-isoprene (SI) block copolymers, multi-armed (SI)ₓ block copolymers, radial block copolymers having an styrene-ethylene-butadiene-styrene (SEBS) backbone and isoprene and/or styrene-isoprene (SI) arms, polyisobutylene, natural rubber, synthetic polyisoprene, and mixtures thereof.

Specific examples of di-block copolymers include, but are not limited to, styrene-butadiene (SB), styrene-isoprene (SI), and the hydrogenated derivatives thereof. Examples of tri-block polymers and tetra-block polymers include, but are not limited to, styrene-butadiene-styrene (SBS), styrene-isoprene-styrene (SIS), α-methylstyrene-butadiene-α-methylstyrene, α-methylstyrene-isoprene-α-methylstyrene, styrene-isoprene-butadiene-styrene (SIBS) and derivatives thereof. Upon hydrogenation of SBS copolymers comprising a rubbery segment of a mixture of 1,4- and 1,2-isomers, a styrene-ethylene-butylene-styrene (SEBS) block copolymer is obtained. Similarly, hydrogenation of an SIS polymer yields a styrene-ethylene-propylene-styrene (SEPS) block copolymer. It is contemplated that functionalized block copolymers can be used, such as succinic anhydride-modified SEBS, which is commercially available as Kraton FG-1901× and 1924× block copolymer from Kraton Polymers in Houston, Tex.

A number of selectively hydrogenated block copolymers are available commercially from Kraton Polymers under the general trade designation “Kraton G”. Thus, particularly suitable block copolymers for the purposes of the present invention include Kraton G 1657 and Kraton G 1730 block copolymers. Kraton G 1657 is a SEBS tri-block copolymer which contains about 13% by weight styrene. Kraton G 1730 is a SEPS tetra-block copolymer which contains about 21% by weight styrene.

Moreover, the adhesive base polymer layer (B) can be made up of high cohesive strength polymers. Since such polymers require relatively high temperatures to process in traditional hot melt manufacturing equipment, they are typically not used in producing a PSA laminate from the melt since at high temperatures, the tackifiers do not withstand such temperatures over an extended period of time. Such high cohesive strength base-polymers may also be applied with the tackifier in the tackifier layer (C) as either a solution or dispersion. Examples of high cohesive strength polymers include, but are not limited to, styrene block copolymers and isobutylene copolymers. Styrene block copolymers include, but are not limited to, styrene-isoprene-styrene block copolymers and copolymers based on styrene and ethylene/butylene (S-E/B—S). In one embodiment of the invention, the polystyrene content of the SIS block copolymer ranges from about 10% to about 50%, preferably from 15% to 30%. In another embodiment of the invention, the solution viscosity of the styrene block copolymers ranges from about 0.05 Pa·s to about 20 Pa·s, preferably from 0.1 Pa·s to 5 Pa·s measured utilizing 25% solids in toluene. In another embodiment of the invention, the molecular weight of the polyisobutylene ranges from about 250,000 to about 5,000,000, preferably from 750,000 to 3,500,000. High cohesive strength polymers are commercially available as Kraton D1111 styrene-isoprene-styrene polymers from Kraton Polymers in Houston, Tex., Oppanol B200 isobutylene copolymers available from BASF, Ludwigshafen, Germany, and Kraton G-1652E S-E/B—S copolymer from Kraton Polymers.

Further examples of useful adhesive base polymers can be found in WO 00/13888, WO 00/17285, and WO 01/96488, incorporated by reference herein in their entirety to the extent they do not contradict the statements herein.

Generally, the adhesive base layer has a thickness that is suitable for the particular PSA laminate application. In one embodiment of the invention, the adhesive base layer has a thickness of about 1 μm to about 60 μm, preferably from about 2 μm to about 40 μm, and most preferably, from 4 μm to 20 μm.

The tackifier layer (C) comprises at least one tackifier. In one embodiment, the tackifier layer (C) comprises at least one tackifer and at least one polymer. In another embodiment, the tackifier layer (C) comprises at least one tackifier, at least one polymer, and at least one plasticizer.

The polymer can be any polymer known in the art suitable for producing PSA laminates. Preferably, the polymer is at least one thermoplastic elastomer. Thermoplastic elastomers were previously discussed in this disclosure.

The tackifier can be any that is known in the art suitable for use in PSA laminates. The tackifer can include, but is not limited to, amorphous tackifier resins of all types known to tackify adhesives, including rosin-based and hydrogenated rosin-based, hydrocarbon-based and hydrogenated hydrocarbon-based, phenolic-based, terpene-based, terpene phenolic-based, styrenated terpene-based, hydrogenated terpene-based, polyester-based, pure monomer aromatic-based, aromatic acrylic-based, liquid resin types, and functionalized types thereof. Note that any of these tackifiers may be in a hydrogenated form.

In one embodiment of the invention, the tackifier layer comprises a liquid tackifier composition. The liquid tackifier composition may be a solution or dispersion of an appropriate tackifier. Such tackifier may be selected on the basis of experiments or existing knowledge with regard to the composition of the pressure sensitive adhesive laminate based on the adhesive base polymer being the major component of the non-adhesive laminate.

In another embodiment of this invention, the tackifier layer (C) may be a blend of polymer (i.e. adhesive base polymer and/or other performance additives) and amorphous resin tackifier resulting in a tackifier master-batch composition. This composition can be formulated for spray ability/high-tack/adhesion and good compatibility with the adhesive base polymer layer.

Optionally, the tackifier layer can further comprise at least one plasticizer. The plasticizer can be any that is known in the art suitable for use in a PSA laminate. Examples of plasticizers include, but are not limited to, naphthenic and paraffinic oils, citrates, sulfonates, and phthalates.

Tackifiers may vary in their compatibility with the adhesive base polymer. In one embodiment of the invention, the tackifier may be preferentially soluble in the adhesive base polymer. This is especially suitable for polystyrene and isoprene type elastomers. Tackifiers that are preferentially solube in polystyrene and isoprene are obtained by polymerization of a stream of aliphatic petroleum derivatives in the form of dienes and mono-olefins containing 5 or 6 carbon atoms, generally in accordance with the teachings of U.S. Pat. No. 3,577,398, herein incorporated by reference in its entirety to the extent it does not contradict statements herein. The resulting hydrocarbon resins range from materials that are normally liquid at room temperatures to materials that are normally solid at room temperature, and typically contain 40% or more by weight polymerized dienes. Such dienes may be, for example, piperylene and/or isoprene. Examples include, but are not limited to, the Piccotac® family of resins (available from Eastman Chemical Company, Kingsport, Tenn., USA) and the Wingtack® family of resins (available from the Chemical Division of Goodyear Tire and Rubber Company, Akron, Ohio). Other solid tackifiers include, but are not limited to, Escorez® 1304 and Escorez® 1310-LC manufactured by Exxon Chemical Company (Houston, Tex.). Further examples include, but are not limited to, modified C₅-type petroleum resins which are made by copolymerizing one or more C₅ monoolefins and/or diolefins with one or more C₈ or C₉ monoalkenyl aromatic hydrocarbons. Examples include, but are not limited to, C₅ monoolefins and diolefins such as isoprene, 2-methyl-1-butene, 2-methyl-2-butene, cyclopentene, 1-pentene, cis- and trans-2-pentene, cyclopentadiene, and cis-trans-1,3-pentadiene. Additional examples of C₈ and C₉ monoalkenyl aromatic compounds are styrene, methylstyrene, and indene.

Other compositions that can be used as tackifiers include, but are not limited to, hydrogenated aromatic resins in which a substantial portion (50% or greater), if not all, of the benzene rings are converted to cyclohexane rings (for example the Regalite™ and Regalrez™ family of resins available from Eastman Chemical, such as, Regalite R 1090, R 1100, R 1125, R 7100, R 9100 and Regalrez 1018, 1094, 3102, 6108, and 1126) and hydrogenated polycyclic resins (typically dicyclopentadiene resins, such as Escorez® 5300, 5320, 5340, 5380, 5400 and 5600, manufactured by Exxon Chemical Company). These tackifiers are especially useful when using an isoprene-based adhesive base polymer.

In another embodiment of the invention, one may further add rosins, rosin esters, polyterpenes, aromatic and functionalized resins and other tackifiers that are compatible to some degree with the adhesive base polymer contained in the adhesive base layer, especially when utilizing polyisoprene or polybutadiene as the adhesive base polymer. Other additives include, but are not limited to, plasticizer oils, such as Shell Flex 371 (from Shell Chemical Company).

In one embodiment, the tackifier layer (C) contains at least one tackifier in an amount of about 50% to about 90% by weight, preferably 70% to 90% by weight, either as a solution or a dispersion. In another embodiment, the tackifier layer (C) comprises a blend of the thermoplastic elastomer, which is present in the non-adhesive laminate, and an amorphous resin tackifier. Preferably, the tackifier layer (C) includes about 2% to about 15% by weight of a thermoplastic elastomer, which may be the same elastomer as present in the adhesive base layer (B) or an elastomer compatible therewith.

Generally, the tackifier layer has a thickness that is suitable for a particular PSA laminate application. In one embodiment of the invention, the tackifier layer has a thickness of about 2 μm to about 150 μm, preferably from 5 μm to 50 μm. Preferably, the liquid tackifer composition, for example, in an aromatic hydrocarbon, such as, toluene or in a suspension is capable of providing a uniform coating on the adhesive base layer (B) that will be about 2 to about 150 μm thick, preferably 5 to 50 μm thick.

Depending on the use of the PSA laminate, the tackifier layer (C) itself may or may not form an effective PSA layer for the purposes of a PSA laminate (e.g. label, etc.). The term “PSA” was previously defined in this disclosure. In other words, if a tackifier layer (C) does not form an effective PSA layer when it is applied to a solid substrate neither the adhesive nor the structural properties (tack and strength) would be sufficient to form a structure (including an adhesive bond) with the properties of a conventional pressure sensitive adhesive laminate.

The outer filmic layer, adhesive base layer, and tackifier layer of the PSA laminate can contain inorganic fillers and other organic and inorganic additives to provide desired properties, such as, but not limited to, appearance properties (opaque or coloured films), durability, and processing characteristics. Examples of useful fillers include, but are not limited to, calcium carbonate, titanium dioxide, metal articles, and fibers. Additives can include, but are not limited to, flame retardants, antioxidant compounds, heat stabilizers, light stabilizers, ultra-violet light stabilizers, anti-blocking agents, processing aids, and acid acceptors, etc. Nucleating agents can be added to increase crystallinity and thereby increase stiffness.

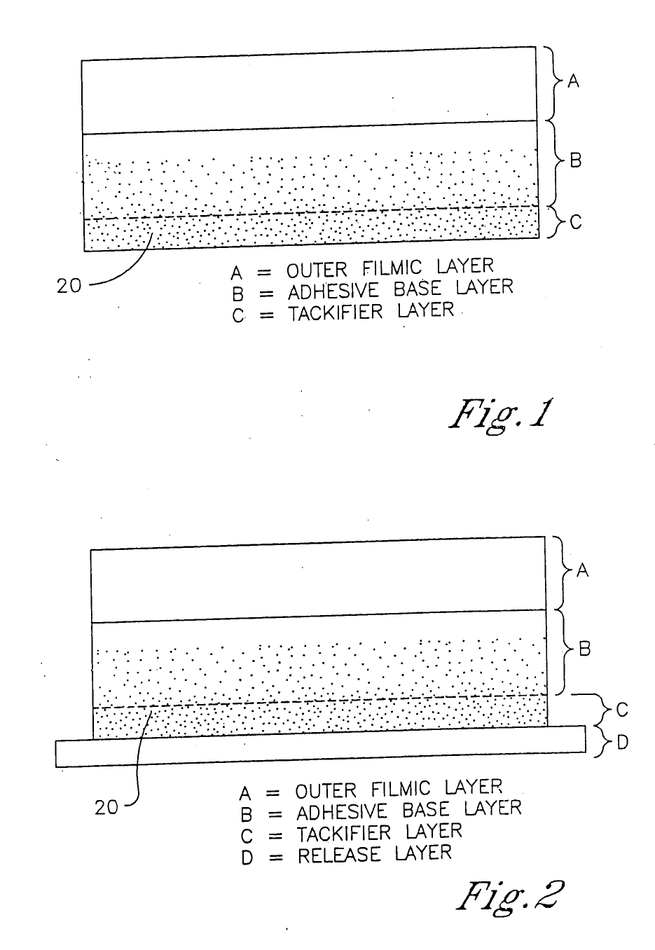

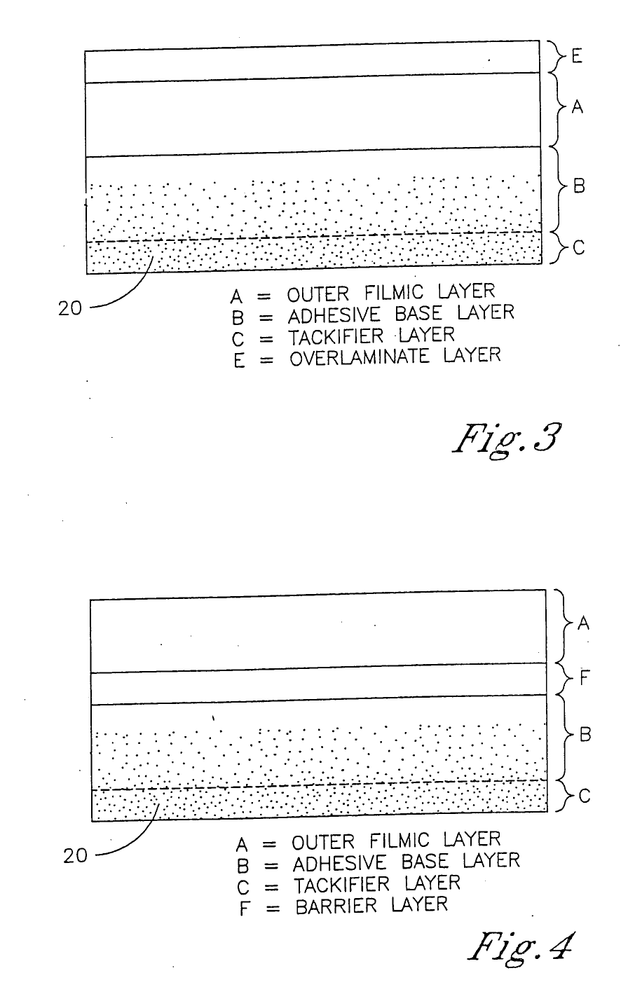

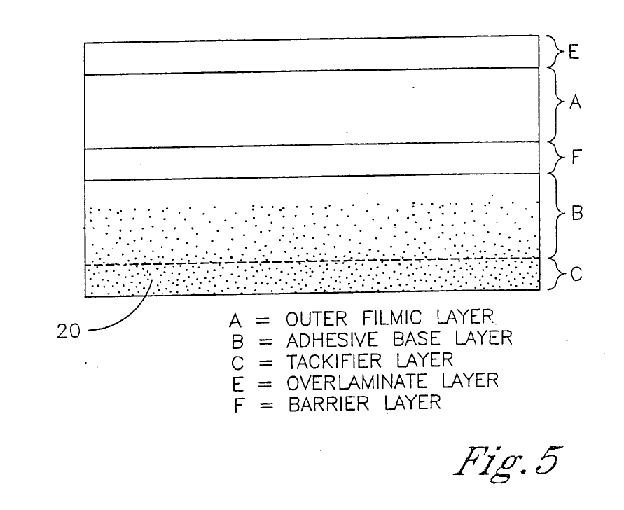

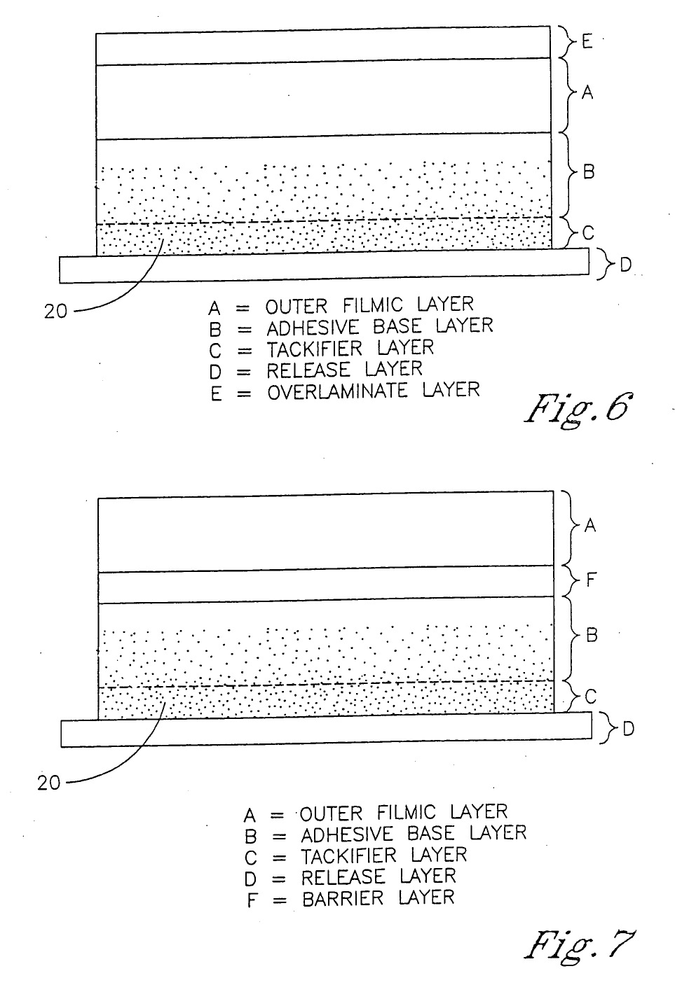

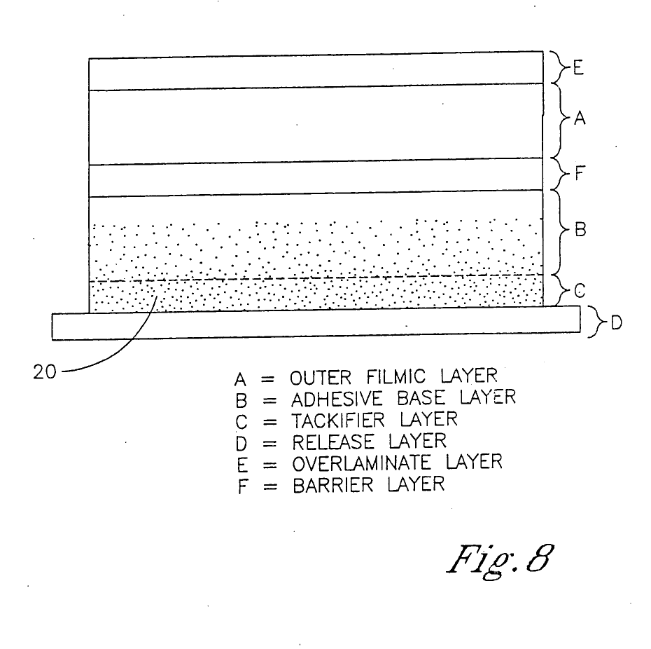

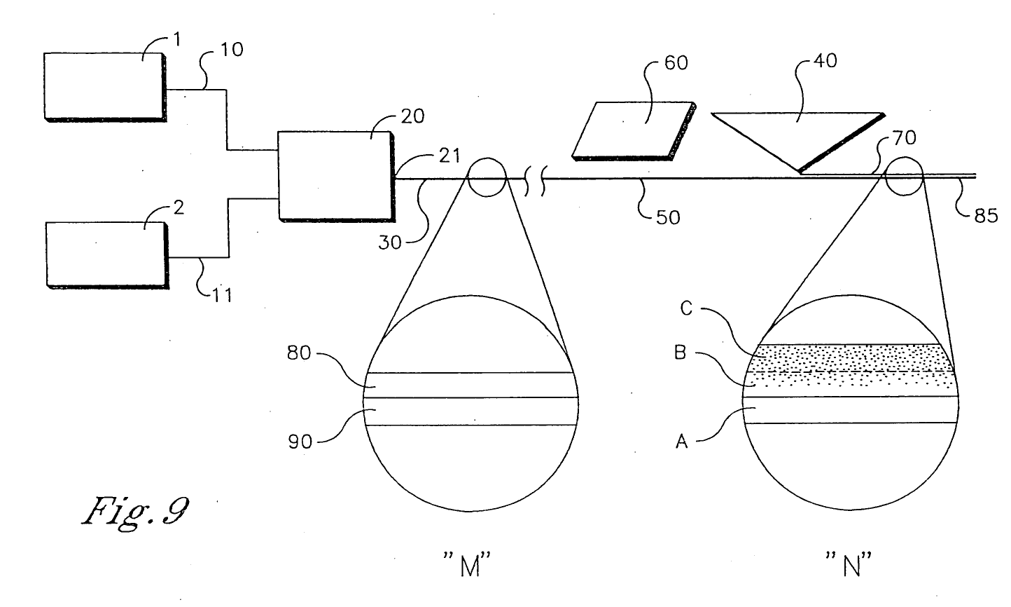

Particular embodiments of the PSA laminate are shown in FIGS. 1-8. In FIG. 1, a PSA laminate is shown comprising an outer filmic layer (A), an adhesive base layer (B), and a tackifier layer (C). As illustrated by dots with varying density (20) in FIGS. 1-8, a molecular weight gradient of tackifier can be observed within the adhesive base layer (B) and the tackifier layer (C). In FIG. 2, a PSA laminate further comprising a release layer (D) is shown. In FIG. 3, a PSA laminate comprising an outer filmic layer (A), an adhesive base layer (B), a tackifier layer (C), and an overlaminate layer (E) is shown. In FIG. 4, a PSA laminate of FIG. 1 is shown further comprising a barrier layer (F) between the outer filmic layer (A) and the adhesive base layer (B). In FIG. 5, a PSA laminate is shown comprising an outer filmic layer (A), an adhesive base layer (B), a tackifier layer (C), an overlaminate layer (E), and a barrier layer (F). FIGS. 6-8 show the PSA laminates of FIGS. 3-5 further comprising a release layer (D). Layers A-F have been previously described in this disclosure.

Typically, the PSA laminate can have a thickness of about 35 to about 400 μm, preferably about 100 μm to about 250 μm, and most preferably from 50 μm to 150 μm. Generally, the PSA laminate can have a thickness ratio of A:B from about 50:1 to about 1:1, preferably 25:1 to 2:1. Thus, the thickness of outer filmic layer (A) may be in the range from about 10 μm to about 200 μm, preferably from about 20 μm to about 100 μm, and most preferably from 30 μm to 90 μm. Adhesive base layer (B) may have a thickness of about 1 to about 60 μm, preferably about 2 to about 40 μm and most preferably, 4 to 20 μm. A particularly suitable PSA laminate may have a thickness of 50-150 μm.

The non-adhesive laminate is formed by a process comprising co-extruding an outer filmic layer (A) comprising at least one filmic polymer and an adhesive base polymer layer (B) comprising at least one adhesive base polymer, which may later on in the process be converted into a pressure sensitive adhesive laminate. The co-extrusion can be conducted by any method known in the art. Examples of processes for co-extruding the outer filmic layer (A) and the adhesive base layer (B) include, but is not limited to, casting and bubble blowing. In one embodiment, the co-extrusion can be conducted by melting the filmic polymer and non-adhesive polymer in separate extruders and delivering the molten streams to an extrusion die from which the outer filmic layer (A) and the adhesive base layer (B) are extruded.

The co-extrusion of the filmic polymer with the adhesive base polymer may be facilitated when the melt viscosities of the two polymers are similar. Thus, the choice of the material to be utilized in the formation of the non-adhesive laminate may depend upon the melt viscosity of the co-extruded materials. In one embodiment of the invention when the filmic polymer is polyethylene, the melt viscosity of the filmic polymer can range from about 0.1 g/10 min to about 15 g/10 min, preferably from 0.1 g/10 min to 5 g/10 min at 190° C. using a 2.16 kg weight. In one embodiment of the invention when the filmic polymer is polypropylene, the melt viscosity of the filmic polymer can range from about 1 g/10 min to about 20 g/10 min, preferably from 0.1 g/10 min to 10 g/10 min at 230° C. using a 2.16 kg weight.

The non-adhesive laminate has a thickness that is suitable for the particular application sought. In one embodiment of the invention, the non-adhesive laminate has a thickness of about 10 μm to about 260 μm, preferably from about 20 μm to about 140 μm, and most preferably, from 30 μm to 80 μm. The thickness of the outer filmic layer can range from about 10 μm to about 200 μm, preferably from about 20 μm to about 100 μm, and most preferably, from 30 μm to 90 μm. The thickness of the adhesive base layer can range from about 1 μm to about 60 μm, preferably from about 2 μm to about 40 μm, and most preferably, from 4 μm to 20 μm The ratio of the outer filmic layer to the adhesive base layer can range from 50:1 to 1:1, preferably from 25:1 to 2:1 and most preferably, 15:1 to 4:1.

Optionally, a number of additional steps can be performed on the non-adhesive laminate or PSA laminate. Thus, for example, the non-adhesive laminate or PSA laminate may be uniaxially or biaxially oriented (e.g., by heat stretching and heat setting). In this context, it is appreciated that the application of the tackifier layer (C) may be effected both before and/or after the stretching occurs. Machine direction or biaxial orientation of the non-adhesive laminate or PSA laminate according to the invention can be accomplished by techniques known in the art. For example, the laminates can be oriented in the machine direction by using tentering frames.

It should be noted at this point, however, that the non-adhesive laminate is, in spite of the presence of at least one adhesive base polymer, not a pressure sensitive adhesive laminate. Thus, in most cases, the laminate will not have any problem of tackiness on heated rolls up to temperatures as high as 100° C.

Accordingly, the non-adhesive nature of the non-adhesive laminate has significant advantages. Thus, this non-adhesive laminate can be easily handled and wound onto itself for later use, i.e. conversion into a PSA laminate. Moreover, the adhesive base polymer of the adhesive base layer in the co-extrusion process can establish/form a bond with the outer filmic layer. Thus, any off-setting that can occur with a normally manufactured, transfer coated, hot melt PSA filmic label can be eliminated. Off-setting is the undesirable transfer of adhesive to a substrate during label removal caused by insufficient anchorage of the adhesive layer onto the filmic layer substrate.

In one embodiment of the present invention, a non-adhesive laminate is provided having a thickness of about 11 to about 210 μm comprising:
a. at least one outer filmic layer comprising at least one filmic polymer and having a thickness of about 10 to about 160 μm, preferably 45 to 150 μm, and
b. at least one adhesive base layer having a thickness of about 1 to about 50 μm comprising at least one thermoplastic elastomer (TPE) selected from the group of TPEs which are capable of forming a pressure sensitive laminate.

The non-adhesive laminate may further comprise an anti-blocking layer having a thickness of about 1 to about 5 μm on top of the outer filmic layer (i.e. not in contact with the adhesive base layer (B)). This optional anti-blocking layer may typically be co-extruded with the outer filmic layer (A) and the adhesive base layer (B). The purpose of this layer is to provide a smoother release or unwind of a rolled up non-adhesive laminate during the coating of the tackifier layer (C).

In one embodiment of the invention, the thermoplastic elastomer and the thickness of the adhesive base layer typically will be selected on the basis of two criteria: (a) strength requirements of the PSA laminate, and (b) capability of the thermoplastic elastomer to form a traditional PSA composition when about 30% to about 95% by weight of the thermoplastic elastomer and about 5% to about 70% by weight of a tackifier are combined (e.g. hot melt) and applied as a tackifier layer (C) to the non-adhesive laminate. In this context, it should be kept in mind that it is the purpose and function of the adhesive base polymer layer to “receive” the tackifier layer (C). Thus, the adhesive base polymer layer typically comprises no tackifier.

In one embodiment of the invention, the outer filmic layer (A) has been co-extruded with the adhesive base polymer layer, and at the interface of these two layers a relatively strong bond will be formed. This implies that any bond of the pressure sensitive adhesive laminate made with a substrate during use of an adhesive label will either fail at the adhesive substrate interface or internally, i.e. cohesive failure. The advantage of this is that it allows a suitable formulation to be made to result in cohesive-failing, tamper evident bonds suitable for security, tamper proof labelling, or for adhesion-interface failure mode, removable labels as well as resealable PSA applications.

In another embodiment of this invention, a process for preparing a PSA laminate is provided. The process comprises co-extruding at least one outer filmic layer (A) comprising at least one filmic polymer and at least one adhesive base layer (B) comprising at least one adhesive base polymer to produce the non-adhesive laminate and applying at least one tackifier layer (C) to the adhesive base layer (B) of the non-adhesive laminate to produce the PSA laminate.

It is envisaged that in forming the PSA layer (B and C) by applying a tackifier layer (C), the tackifier will diffuse into the adhesive base layer (B) such that a molecular weight gradient from tackifier layer (C) (low molecular weight) to adhesive base layer (B) (high molecular weight) will form. This leaves a low molecular weight, high-tack layer at the surface of (C) exactly where this functionality is required to create pressure sensitive bonds. Conversely, in the high molecular weight portion of the PSA layer (B & C) enhanced and improved shear resistance, creep resistance and high temperature performance may be observed.

The PSA laminate can be produced by any method known in the art. In one embodiment of the invention, the PSA laminate can be produced in a one-step extrusion/spray-coating process, and the obtained PSA laminate may be self-wound or laminated to a backing paper (e.g. silicone backing paper) and wound, creating PSA tape or label structures, respectively. Such PSA laminate will thus be created cost-effectively. In particular, the tackifier layer (C) can be coated at very low temperatures, typically up to 100° C. lower than with traditional hot-melt pressure sensitive adhesives. This may improve the manufacturing process in at least one of the following ways: (1) heat sensitive outer filmic layers, e.g. polyethylene, may be direct coated compared to the usual method of transfer coating; (2) process costs are lower; (3) a tackifier master-batch composition may be expected to have better heat aging properties, less colour loss, less charring in comparison to PSA laminates that have been conventionally processed or coated at high temperatures (with the tackifier in the PSA composition) which can exhibit gelling and/or charring due to an extended heat history.

It can be particularly advantageous to “assemble” the final PSA laminate at a different location from the production facility for the manufacture of the non-adhesive laminate. The non-adhesive laminate can be self-wound and stored for an indefinite time. In a second process step, the non-adhesive laminate (A & B) can then be further processed, for example, on a (narrow web) label press which is suitably modified for spraying or coating of the tackifier layer (C) onto the non-adhesive laminate to form the pressure sensitive adhesive layer (B and C), thereafter laminated with off-line produced release paper or release film (D), where the finished label would then be processed and used as a traditionally manufactured label laminate. To further reduce the costs, it is envisaged that such process could take place in-line with the printing and converting of the label where the finished label would then be applied directly to the article to be labelled. This would obviate the need for a silicone backing support and would further reduce the costs.

The conversion of the non-adhesive laminate can be effected either in one production line (on-line) or off-line at a different location. This conversion typically will be implemented by applying the tackifier layer (C) to the second surface (or under surface) of the non-adhesive laminate (i.e. that is the surface of the non-adhesive laminate that is not in contact with the outer filmic layer (A)). Tackifier layer (C) may be applied on the adhesive base layer (B) either directly or indirectly. In an indirect (or transfer) coating process, tackifier layer (C) may be first coated on an intermediary carrier (e.g. siliconized paper) and then transferred to adhesive base polymer layer (B).

The conversion of the non-adhesive laminate may require that the laminate is heated. Heating may be effected in the stretching process or separately by means of e.g. infra-red heaters. Such a heating helps propagate the diffusion mechanism of the tackifier into the adhesive base layer and converts the non-adhesive laminate into a PSA laminate. Another advantage is that this tackifier layer (C) can be coated onto the non-adhesive laminate at very low temperatures, typically up to 100° C. less than the required temperature for traditional hot melt pressure sensitive adhesives.

In one embodiment of the invention, the tackifier is a liquid or has been liquified (by melting, adding of solvent, forming of dispersion). Suitable solvents include hydrocarbons such as toluene. Dispersions may be formed with water and/or alcohols. Thus, the present invention further suggests tackifier compositions which essentially comprise one of the previously described tackifiers with either a solvent or dispersant and other additives.

In general, a PSA laminate according to the invention can have a thickness of about 35 to about 400 μm, preferably from 100 to 200 μm. However, other laminates are contemplated to be within the scope of the invention. e.g. faceless PSA constructions as described in US 2003198737, herein incorporated by reference to the extent it does not contradict statements herein. Accordingly, in applying the tackifier layer (C), both the layer thickness to be applied to the non-adhesive laminate and the concentration of the tackifier in the layer are of some concern. The ranges for tackifier concentration in the tackifier layer (C) and the thickness were discussed previously in this disclosure. Thus, one function of the tackifier layer (C) is to provide a reservoir or source for a tackifier to migrate into the adhesive base layer to form the PSA laminate. An additional concern is the choice of solvent/dispersant, which on the one hand, could facilitate the migration of the tackifier into the adhesive base polymer layer, but on the other hand, should not be present in an amount to effectively swell the adhesive base polymer layer.

In one embodiment of the invention, the tackifier layer (C) itself does not form the PSA. The term “PSA” was previously defined in this disclosure. In this embodiment, both the concentration of the tackifier and the viscosity of the tackifier (which can account for the easiness of the application of the tackfier composition to the adhesive base layer) would be insufficient to form an effective pressure sensitive adhesive laminate.

In another embodiment, the tackifier layer (C) forms a PSA. The term “PSA” was previously defined in this disclosure.

The tackifier layer (C) may comprise other additives that serve different purposes. For instance, polystyrene reinforcing additives may be present. Moreover, other components can be added to improve the stability, impart structural reinforcement, improve coatability, or impart some other desirable properties. Accordingly, the tackifier layer (C) may include stabilizers which inhibit oxidative degradation of the adhesives and pigments.

FIG. 2 represents a schematic overview of one embodiment of the process for preparing the PSA laminate according to the present invention. In a co-extrusion technique, two extruders 1 and 2 are utilized which provide two molten streams through lines 10 and 11 to the co-extrusion die 20. Extruder 1 provides a molten stream 10 of the adhesive base layer which comprises at least one adhesive base polymer and extruder 2 provides a molten stream 11 of the filmic outer layer comprising at least one filmic polymer. The extruders 1 and 2 are used to melt the polymers and pumps are provided to deliver the molten streams to the extrusion die 20. The precise extruder utilized is not critical to the process. A number of useful extruders are known, and these include, but are not limited to, single and twin-screw extruders, etc. Such extruders are available from a variety of commercial sources including Killion Extruders, Inc., C.W. Brabender, Inc., American Leistritz Extruder Corp., and Davis Standard Corp. A variety of useful co-extrusion die systems are known. Examples of extrusion dies useful in this invention are so-called “vane” dies, and multimanifold dies available from the Cloeren Company of Orange, Tex. Referring again to FIG. 2, the molten non-adhesive laminate 30 of at least two layers exits the extrusion die 20 through orifice 21. This non-adhesive laminate (as shown in detail M in FIG. 2) comprises the outer filmic layer 90 and the adhesive base layer 80 of the present invention.

The non-adhesive laminate can then be further processed by any method known in the art. For instance, a number of additional steps can be performed on the non-adhesive laminate. The non-adhesive laminate of the present invention can either be collected for future processing, overlaminating and converting at a different time and/or geographic location, or these laminates can be routed to one or more other stations for printing, overlaminating, and/or converting during the same operation. In the example shown in FIG. 2, the non-adhesive laminate is coated by a coating head 40 forming a tackifier layer 70 of the tackifier composition on the adhesive base layer 80. It may be occasionally necessary to heat the non-adhesive laminate 50 before or after applying the tackifier layer (C). Thus, the presence of a heater 60 (e.g. infra-red heater) may be desirable. Note that heater 60 can be located after the application of the tackifier layer 70 by coating head 40. Once the tackifier layer 70 has been applied, the non-adhesive laminate will “convert” into the final product, the PSA laminate comprising outer filmic layer (A) and pressure sensitive adhesive layer (B and C) (as shown in detail N in FIG. 2) formed from the adhesive base layer 80 and tackifier layer 70, in a relatively short time (a few mintues to hours). This PSA laminate can be further processed by printing and applying the laminate to a substrate. Alternatively, a liner may be combined with the PSA laminate if the PSA laminate shall be collected for later use.

### EXAMPLES

The following methods were utilized in these examples 2-6.

Loop tack was determined according to FINAT FTM 9 using stainless steel instead of glass.

Peel adhesion was determined following AFERA 5001, test method A.

Shear adhesion was determined following AFERA 5012, procedure A.

### Example 1

A nonadhesive laminate comprised of an outer filmic layer of primarily polypropylene (PP) (80%) and an adhesive base layer of Kraton G1657 TPE (20%) was made on a coextrusion line operating with two Killion 1 inch single screw extruders with 24/1 UD. The output from the two extruders directly entered a combining block adaptor where the two flow streams were combined to form a 2 layer flow profile with the adhesive base layer (Kraton TPE) on top to produce a combined polymer melt stream. The combined polymer melt stream entered a 6 inch wide film die where the flow profile spread out into the final laminate dimension to produce the nonadhesive laminate. The nonadhesive laminate was cast onto a chill roll at 30° C. and wound into rolls with release paper applied between the layers to prevent possible sticking. The extrusion parameters are tabulated below.

TABLE 1

| | | | | | | | Layer | Chill |
|---|---|---|---|---|---|---|---|---|
| Extruder | Zone 1 | Zone 2 | Zone 3 | Rpm | Feedblock | Die | Thickness | Roll |
| Kraton | 200° C. | 205° C. | 205° C. | 25 | 220° C. | 225° C. | 6 mils | 30° C. |
| G1657 TPE | | | | | | | | |
| Huntsman | 190° C. | 220° C. | 220° C. | 100 | 220° C. | 225° C. | 27 mils | 30° C. |
| P4G2Z PP | | | | | | | | |

The coextruded nonadhesive laminate rolls exhibited edges comprised of 100% Kraton TPE due to the fact that the TPE flowed more to the edges in the film die than the outer filmic layer, made from a 1.5 MFR polypropylene homopolymer. Polypropylene with a nominal 4.0 MFR would have given higher flow and better layer distribution in the coextruded nonadhesive laminate.

In nonadhesive laminate sample A, the outer filmic layer contained 100% polypropylene polymer. In nonadhesive laminate sample B, the outer filmic layer contained 90% by weight of the polypropylene polymer combined with 10% by weight of Regalite R-1100 hydrocarbon resin from Eastman Chemical Company. In nonadhesive laminate sample C, the outer filmic layer contained 80% by weight of the polypropylene polymer combined with 20% by weight Regalite R-1100 hydrocarbon resin, while in nonadhesive laminate sample D, the Regalite R-1100 hydrocarbon resin level was increased to 30% by weight. Adding the Regalite R-1100 resin to the polypropylene reduced its melt viscosity, and it was noted that as the amount of the hydrocarbon resin in the outer filmic layer increased the layer distribution became more uniform due to the lower melt viscosity of the outer filmic layer. In all cases, the nominal laminate thickness was about 33 mils with the adhesive base layer comprising about 18% of the total structure in the center of the samples.

Preparation of Oriented Nonadhesive Laminates Having Adhesive Base Layer of Kraton® TPE

Each of the thick, nonadhesive laminate samples B, C, and D were stretched into oriented, nonadhesive laminate specimens by stretching 4× by 4× using a tenter frame film stretcher manufactured by the T.M. Long Company. Small specimens 10 cm×10 cm were inserted into the clips of the stretcher, and the specimens were heated to 140° C. After heating, the nonadhesive laminate specimen was stretched in both directions simultaneously at a strain rate of about 150%/second until the final laminate dimensions were reached. The nominal thickness of the final oriented, nonadhesive laminates was about 2.2 mils where the laminates retained a surface layer of Kraton G-1657 about 0.4 mil thick. The oriented, nonadhesive laminates made from starting laminates B, C, and D were designated B1, C1, and D1, respectively. The Regalite R-1100 resins in the outer filmic layer made the layer easier to stretch, and it was noted that laminate B with only 10% Regalite hydrocarbon resin had poorer layer uniformity than the other two laminates. These laminates did not exhibit good film flatness which made subsequent coating of the surface of the adhesive base layer more difficult. None of the oriented, nonadhesive laminates exhibited measurable tack or adhesion properties.

In a similar manner, the starting nonadhesive laminate specimens B, C, and D were stretched 3×3 into oriented, nonadhesive laminates at 140° C. at a draw strain rate of about 250% per second using the same T,M. Long tenter frame stretcher with the final nonadhesive laminate samples designated as B2, C2, and D2. The average oriented, nonadhesive laminate thickness was about 3.8 mils and significant thickness variability was noted largely due to the excessively high draw strain rate. Again, laminates with the highest Regalite hydrocarbon resin concentration exhibited the best stretch behavior. The oriented nonadhesive laminates exhibited visible surface irregularities. None of the oriented nonadhesive laminates exhibited measurable tack or adhesion properties.

Coating of Oriented, Nonadhesive Laminate Specimens C2 and D2

Oriented nonadhesive laminates C2 and D2 that had been oriented 3×3 to a nominal 3.6 mil thickness having an adhesive base layer of Kraton G-1657 about 0.6 mil thick were noted to posses negligible adhesive properties. To form a PSA laminate, a solution of Regalrez 1018 liquid hydrogenated tackifier resin in cyclohexane was coated onto the surface of the adhesive base layer of the oriented, nonadhesive laminate using a wire wrapped coating rod. Enough cyclohexane was added to reduce the viscosity so that the tackifier resin could be easily coated. The coating was performed so that the amount of dried Regalrez 1018 applied was about 30%-40% by weight of the starting nonadhesive laminate specimen weight.

Initially, the surface of the PSA laminate was very slimy due to the coating of the liquid tackifier resin. After aging, the PSA laminate for 2 hours in an oven at 60° C., the surface was converted to a tacky state that was very different from the initial dried surface coating of Regalrez 1018 tackifier resin. The PSA laminates were cut into 1 inch wide strips which were press applied to stainless steel panels, and the 1800 peel properties were measured with the peel values reported in terms of ounces force ( 1/16 pound force) per inch width.

TABLE 2

| | Oriented | | Regalrez | | |
|---|---|---|---|---|---|
| | Non- | | 1018 To | Peel Force | |
| Example | adhesive | Coating | Kraton G | (oz_{f}/in. width) | |
| No. | Laminate | (% Wt. Gain) | Ratio | Average | Range |
| 1.1 | C2 | 39% | 2.2 | 39 | 30-44 |
| 1.2 | D2 | 31% | 1.7 | 48 | 32-57 |
| 1.3 | D2 | 41% | 2.3 | 56 | 52-60 |

The nonadhesive laminates were observed to demonstrate minimal tack or PSA adhesion to the metal substrate. Immediately after applying and air drying the Regalrez 1018 tackifier resin, the surface was slimy with very sticky character but with little adhesive strength because the coating was simply a viscous liquid. After aging for about an hour at 60° C., the liquid tackifier resin diffused into the adhesive base layer (Kraton G1657 TPE) so that the surface became a tacky semi-solid exhibiting typical viscoelastic properties of a PSA formulation. The peel forces measured from these specimens represent good PSA adhesion.

Coating of Oriented Nonadhesive Laminate Specimens C1 and D1

Specimens of oriented nonadhesive laminate samples C1 and D1 were coated with an 80% solution of Regalrez 1018 tackifier resin in cyclohexane using a wire wrapped rod in order to achieve a dried coating weight applied to the surface of the adhesive base layer (Kraton G TPE) amounting to about 40% to 50% by weight of the starting oriented nonadhesive laminate weight to produce PSA laminates. The starting oriented nonadhesive laminates exhibited minimal tack or adhesion properties, but after coating, drying, and aging the PSA laminates for 1 hours at 60° C., the PSA laminates were noted to behave like a PSA. The PSA laminates were cut into 1 inch wide specimens applied to stainless steel panels to form test specimens for both 1800 peel testing and loop tack testing. The adhesion properties measured for these PSA laminates are listed below.

TABLE 3

| | | | Regalrez | | |
|---|---|---|---|---|---|
| | Oriented | | 1018 to | Loop Tack | 180° Peel |
| Example | Nonadhesive | Coating | Kraton G | (Oz. | (Oz./in |
| No. | Laminate | Wt. Gain | Ratio | force) | width) |
| 1.4 | C1 | 47% | 2.6 | 67 | — |
| 1.5 | C1 | 55% | 3.1 | — | 50 |
| 1.6 | D1 | 43% | 2.4 | 47 | — |
| 1.7 | D1 | 50% | 2.8 | — | 53 |

Again, diffusion of the applied liquid tackifier layer into the adhesive base layer (Kraton G TPE) of the oriented nonadhesive laminate converted the originally non-tacky adhesive base layer surface into a PSA laminate exhibiting good PSA properties after aging. Because of variations in laminate thickness across the specimens combined with variability in coating weight across the specimens, there was undesirable variation in the ratio of applied tackifier to TPE at the surface. This resulted in substantial variation in PSA properties across the specimens. However, these examples serve to demonstrate the principle that when a tackifier formulation is applied to the surface of the adhesive base layer of a coextruded nonadhesive laminate construction, the tackifier species can diffuse into the adhesive base layer (TPE) with time so that the final PSA laminate will exhibit PSA properties dependent on the relative amount and type of tackifier coating applied to the adhesive base layer surface.

### Examples 2-7

Tackifier layer compositions were produced containing SEBS copolymer obtained as Kraton G1730 and Regalite R1090 and Regalrez 1018 tackifiers. Irganox 1010 antioxidant was also added. The amount of SEBS copolymer varied from 0-25% by weight. The amount of tackifier and antioxidant was changed according to the increase in the SEBS copolymer. The amounts are specified in Tables 1-6. These compositions were used to produce a tackifier layer (C) on a non-adhesive laminate.

The outer filmic layer of the non-adhesive laminate was made of Sabic low density polyethylene obtained by Sabic Europe in Sittard, The Netherlands, and the adhesive base layer was Kraton G1730 SEBS block copolymer. The low density polyethylene had a density of 0.924 and a melt flow index of 0.75 g/10 min at 190° C. using a 2.26 kg weight. In addition, the non-adhesive laminate contained an anti-blocking layer on the surface of the outer filmic layer away from the adhesive base layer. A low density polyethylene containing 3% silica was utilized for the anti-blocking layer.

The nonadhesive laminate was produced by co-extruding the low density polyethylene, SEBS block copolymer, and the anti-blocking layer. A cast film extrusion line was utilized having three separate extruders. The extruder for the outer filmic layer contained 6 zones and operated at an inlet temperature of about 170° C. and an outlet temperature of about 220° C. The extruders for the adhesive base layer and the anti-blocking layer contained 3 zones and operated at an inlet temperature of about 180° C. to 190° C. and an outlet temperature of about 210° C. The outer filmic layer of polyethylene represented 32% of the total; the adhesive base polymer represented 12% of the total extruded amount; and the anti-blocking layer amounted to 56% of the total amount extruded. The melt from the extruders were routed to a cloerenblok feed block and then to a Black Clawson Spuitkop die. The die temperature was in the range of about 250° C. to about 260° C., and the web speed was 21.3 m/min. After casting, the nonadhesive laminate was cooled and rewound.

The tackifier layer compositions were transfer coated (24 gsm) onto the non-adhesive laminate to produce a pressure sensitive adhesive laminate using a hot melt die coater onto a release liner. The pressure sensitive laminates were were tested for peel adhesion, loop tack and shear resistance properties, initial, after 1 hr, 24 hrs, 48 hrs, 1 week and 2 weeks. The data are tabulated in Tables 1-6.

The PSA laminate with 0% SEBS in the tackifier layer, a tack and shear increase was observed. The PSA laminate with 5% SEBS in the tackifier layer showed first a tack increase and than a tack decrease after 24 hours. The shear increased even to >10 K after 48 hrs storage at room temperature. The PSA laminates having 10% and 15% SEBS both showed tack decreases and shear increases after 1 hr with the shear increasing to greater than 10 K after 24 hours. This illustrates that migration of the polymer in the tackifier layer (C) to the adhesive base layer (B) has occurred. The PSA laminates at 20% and 25% displayed good PSA properties immediately. The tack decrease for these PSA laminates can be explained since the PSA laminates contained too much polymer after migration.

Migration of the tackifier layer into the adhesive polymer layer can be demonstrated by the significant increase in the shear adhesion values. Adhesion properties would decrease with all C-layers that contain SEBS can be due to the fact that in fact the formulations contained too much polymer after migration.

PSA laminates containing 0% SEBS & 5% SEBS in the tackifier layer (C) showed off-setting to the release paper. The offsetting stopped after 1 week of storage at room temperature, confirming migration of the tackifier layer (C) into the adhesive base layer (B).

TABLE 4
Example 2: Tackifier Layer (C): Kraton G1730 (0 wt %)/Regalite R1090
(40.4 wt %)/Regalrez 1018 (59.3 wt %)/Irg. 1010 (0.3 wt %)

| | | Initial | 1 Hr | 24 Hrs | 48 Hrs | 1 week | 2 weeks | 3 weeks |
|---|---|---|---|---|---|---|---|---|
| Peel adhesion to steel | AV | 3.6 | 3.8 | 6.6 | 6.5 | 6.3 | 5.2 | 8 |
| (N/mm²) | SD | (0.5) | (0.4) | (0.3) | (0.2) | (0.7) | (0.6) | (0.7) |
| Failure mode | | cf**/ss | cf**/ss | cf**/lss | cf*/lss | cf | cf | cf |
| Loop tack to steel | AV | 3.9 | 3.5 | 6.3 | 11.8 | 9.2 | 0.9 | 5.8 |
| (N/mm²) | SD | (0.9) | (1.1) | (0.3) | (2.2) | (1.7) | (0.3) | (2.7) |
| Failure mode | | cf/ss | cf/ss | cf/ss | cf/ss | cf/ss | cf/ss | cf/ss |
| Shear adhesion to steel | AV | 39 | 35 | 94 | 201 | 478 | 1843 | |
| 1 Kg (min) | SD | (2) | (6) | (42) | (33) | (231) | (1310) | |
| Failure mode | | cf | cf | cf | cf | cf | cf | |

Initial to 48 hrs offsetting of the tackifier layer to relese paper and fingers. After 1 week, this was not observed.
AV—average
SD—standard deviation
cf—cohesive failure
ss—slip stick
**total transfer of tackifier layer to steel plate
*75% total offsetting of tackifier to steel plate

TABLE 5
Example 3: Tackifier Layer (C): Kraton G1730 (5.3 wt %)/Regalite
R1090 (42.1 wt %)/Regalrez 1018 (51.6 wt %)/Irg. 1010 (1.1 wt %)

| | | Initial | 1 Hr | 24 Hrs | 48 Hrs | 1 week | 2 weeks | 3 weeks |
|---|---|---|---|---|---|---|---|---|
| Peel adhesion to steel | AV | 10.5 | 11.9 | 9.2 | 8.9 | 9.9 | 7.7 | 6.9 |
| (N/mm²) | SD | (0.6) | (1.0) | (0.6) | (0.6) | (0.8) | (0.7) | (0.3) |
| Failure mode | | cf/ss | cf/ss | cf/ss | cf/lss | cf | cf | |
| Loop tack to steel | AV | 4.6 | 8.1 | 7.0 | 6.5 | 1.0 | 9.9 | 9.6 |
| (N/mm²) | SD | (1.2) | (1.8) | (1.2) | (1.7) | (0.9) | (1.7) | (2.7) |
| Failure mode | | cf/ss | cf/ss | lcf/ss | lcf/ss | lss | ss | ss |
| Shear adhesion to steel | AV | 155 | 167 | 1076 | >10K | >10K | >10K | |
| 1 Kg (min) | SD | (7) | (32) | (527) | | | | |
| Failure mode | | cf | cf | cf | | | | |

Initial to 48 hrs offsetting of the tackifier layer to relese paper and fingers. After 1 week, this was not observed.

TABLE 6
Example 4 Tackifier Layer (C): Kraton G1730 (10 wt %)/Regalite
R1090 (37.5 wt %)/Regalrez 1018 (51.5 wt %)/Irg. 1010 (1 wt %)

| | | Initial | 1 Hr | 24 Hrs | 48 Hrs | 1 week | 2 weeks | 3 weeks |
|---|---|---|---|---|---|---|---|---|
| Peel adhesion to steel | AV | 16.5 | 17.0 | 13.9 | 12.1 | 8.0 | 6.5 | 5.9 |
| (N/mm²) | SD | (0.6) | (0.5) | (2.0) | (0.2) | (1.5) | (1.1) | (0.6) |
| Failure mode | | Cf | cf | cf | cf 85% | cf 20% | | |
| Loop tack to steel | AV | 21.4 | 12.0 | 18.5 | 8.7 | 7.9 | 9.6 | 3.7 |
| (N/mm²) | SD | (2.0) | (0.7) | (0.8) | (3.4) | (0.7) | (1.3) | (1.1) |
| Failure mode | | cf/ss | cf/ss | lcf/ss | lcf/ss | lcf/ss | ss | ss |
| Shear adhesion to steel | AV | 94 | 108 | >10K | >10K | >10K | >10K | |
| 1 Kg (min) | SD | (9.7 | (40) | | | | | |
| Failure mode | | | | | | | | |

TABLE 7
Example 5 - Tackifier Layer (C): Kraton G1730 (15 wt %)/Regalite
R1090 (34.9 wt %)/Regalrez 1018 (49 wt %)/Irg. 1010 (1 wt %)

| | | Initial | 1 Hr | 24 Hrs | 48 Hrs | 1 week | 2 weeks | 3 weeks |
|---|---|---|---|---|---|---|---|---|
| Peel adhesion to steel | AV | 17.2 | 16.6 | 14.7 | 14.3 | 7.5 | 6.5 | 6.3 |
| (N/mm²) | SD | (0.3) | (0.6) | (2.2) | (1.5) | (1.6) | (0.6) | (0.3) |
| Failure mode | | Cf | Cf | cf 75% | cf 35% | | | |
| Loop tack to steel | AV | 34.1 | 36.4 | 5.8 | 11 | 10.7 | 10.4 | 8.1 |
| (N/mm²) | SD | (0.4) | (1.6) | (2.1) | (2.8) | (1.2) | (2.8) | (1.0) |
| Failure mode | | Cf | Cf | lcf/ss | lcf/ss | ss | | |
| Shear adhesion to steel | AV | 135 | 223 | >10K | >10K | >10K | >10K | >10K |
| 1 Kg (min) | SD | (26) | (36) | | | | | |
| Failure mode | | Cf | Cf | | | | | |

TABLE 8
Example 6 - Tackifier Layer (C): Kraton G1730 (20 wt %)/Regalite
R1090 (32.5 wt %)/Regalrez 1018 (46.5 wt %)/Irg. 1010 (1 wt %)

| | | Initial | 1 Hr | 24 Hrs | 48 Hrs | 1 week | 2 weeks | 3 weeks |
|---|---|---|---|---|---|---|---|---|
| Peel adhesion to steel | AV | 18.1 | 16.8 | 13.3 | 12.6 | 7.0 | 5.5 | 5.4 |
| (N/mm²) | SD | (1.4) | (0.4) | (1.7) | (3.0) | (1.4) | (0.7) | (0.3) |
| Failure mode | | cf 40% | cf 40% | | | | | |
| Loop tack to steel | AV | 17.9 | 17.6 | 15.7 | 11.4 | 14.4 | 10.7 | 8.6 |
| (N/mm²) | SD | (1.6) | (4.6) | (3.6) | (1.8) | (0.9) | (2.6) | (1.6) |
| Failure mode | | lcf/ss | lcf/ss | lcf/ss | lcf/ss | lss | | |
| Shear adhesion to steel | AV | >10K | >10K | >10K | >10K | >10K | >10K | >10K |
| 1 Kg (min) | SD | | | | | | | |
| Failure mode | | | | | | | | |

TABLE 9
Example 7 - Tackifier Layer Composition: Kraton G1730 (25.2 wt %)/Regalite
R1090 (44.3 wt %)/Regalrez 1018 (30.2 wt %)/Irg. 1010 (0.3 wt %)

| | | Initial | 1 Hr | 24 Hrs | 48 Hrs | 1 week | 2 weeks | 3 weeks |
|---|---|---|---|---|---|---|---|---|
| Peel adhesion to steel | AV | 9.7 | 13.9 | 7.5 | 6.4 | 5.3 | 5.3 | 4.4 |
| (N/mm²) | SD | (2.1) | (1.1) | (0.5) | (0.6) | (0.8) | (1.1) | (0.7) |
| Failure mode | | cf 5% | | | | | | |
| Loop tack to steel | AV | 25.3 | 24.1 | 14.2 | 13.5 | 11.2 | 6.7 | 3.4 |
| (N/mm²) | SD | (2.9) | (0.7) | (1.2) | (1.0) | (0.9) | (1.5) | (1.1) |
| Failure mode | | cf/ss | cf/ss | ss | ss | | | |
| Shear adhesion to steel | AV | >10K | >10K | >10K | >10K | >10K | >10K | >10K |
| 1 Kg (min) | SD | | | | | | | |
| Failure mode | | | | | | | | |

That which is claimed is:

1. A pressure sensitive adhesive (PSA) laminate comprising
a. at least one outer filmic layer (A) comprising at least one filmic polymer;
b. at least one adhesive base layer (B) comprising at least one adhesive base polymer; and
c. at least one tackifier layer (C) comprising at least one tackifier;
wherein said pressure sensitive adhesive laminate is obtainable by co-extruding said outer filmic layer (A) with said adhesive base layer (B) to produce a non-adhesive laminate and applying said tackifier layer (C) to said non-adhesive laminate to produce said PSA laminate.

2. A PSA laminate according to claim 1 further comprising at least one layer selected from the group consisting of at least one barrier layer, at least one overlaminate layer, at least one release liner, at least one tie layer, and at least one primer layer.

3. A PSA laminate according to claim 1 or 2 wherein a release material is located on the outer surface of said outer filmic layer.

4. A PSA laminate according to claim 3 wherein said release material is a silicone material.

5. A PSA laminate according to claim 1 or 2 wherein said filmic polymer is a blend of filmic polymers or a multi-layer film of various filmic polymers.

6. A PSA laminate according to claim 1 or 2 wherein said filmic polymer has a solubility parameter that is inconsistent with or incompatible with said adhesive base polymer to prevent migration between said outer filmic layer and said adhesive base layer.

7. A PSA laminate according to claim 1 or 2 wherein said filmic polymer is selected from the group consisting of polystyrenes, polyolefins, polyamides, polyesters (e.g. polyethylene terephthalate), polycarbonates, polyurethanes, polyacrylates, polyvinyl alcohols, polyesters, functional polyesters (e.g. sulfopolyesters), poly(ethylene vinyl alcohols), polyether block polyamides, polyvinyl acetates, and mixtures thereof.

8. A PSA according to claim 7 wherein said filmic polymer is a polyolefin having repeating units selected from the group consisting of ethylene, propylene, and 1-butene.

9. A PSA according to claim 8 wherein said filmic polymer is at least one selected from the group consisting of polyethylene, polypropylene and ethylene-propylene copolymer.

10. A PSA laminate according to claim 7 wherein the melt flow rate (MFR) of polyethylene used in said outer filmic layer ranges from about 0.1 to about 15 g/10 minutes measured at 190° C. using a 2.16 kg weight.

11. A PSA laminate according to claim 10 wherein the melt flow rate of polyethylene used in said outer filmic layer ranges from 0.1 to 5 g/10 minutes measured at 190° C. using a 2.16 kg weight.

12. A PSA laminate according to claim 7 wherein the melt flow rate (MFR) of polypropylene used in said outer filmic layer ranges from about 0.1 to about 20 g/10 minutes measured at 230° C. using a 2.16 kg weight.

13. A PSA laminate according to claim 12 wherein the melt flow rate (MFR) of polypropylene used in said outer filmic layer ranges from about 0.1 to about 10 g/10 minutes measured at 230° C. using a 2.16 kg weight.

14. A PSA laminate according to claim 1 or 2 wherein said outer filmic layer has a thickness of about 10 μm to about 200 μm.

15. A PSA laminate according to claim 14 wherein said outer filmic layer has a thickness of about 30 μm to about 90 μm.

16. A PSA laminate according to claim 1 or 2 wherein said adhesive base polymer is at least one selected from the group consisting of at least one random copolymer adhesive base material, at least one block copolymer adhesive base polymer, and at least one natural or synthetic rubber.

17. A PSA laminate according to claim 16 wherein said random copolymer adhesive base material is selected from the group consisting of copolymers based upon acrylate and/or methacrylate copolymers, α-olefin copolymers, silicone-copolymers, and chloroprene/acrylonitrile copolymers.

18. A PSA laminate according to claim 16 wherein said block copolymer adhesive base polymer is selected from the group consisting of linear block copolymers, branched block copolymers, star block copolymers, grafted, and radial block copolymers.

19. A PSA laminate according to claim 16 wherein said natural or synthetic rubber is selected from the group consisting of polyisobutylene, polyisoprene, and butyl rubber.

20. A PSA laminate according to claim 1 or 2 wherein said adhesive base polymer comprises at least one thermoplastic elastomer (TPE).

21. A PSA laminate according to claim 20 wherein said TPE is a least one selected from the group consisting of linear, branched, graft or radial block copolymers.

22. A PSA laminate according to claim 21 wherein said thermoplastic elastomers comprise from about 75% to about 95% by weight of rubbery segments and from about 5% to about 25% by weight of non-rubbery segments.

23. A PSA laminate according to claim 22 wherein said non-rubbery segments comprise polymers of mono- and poly-cyclic aromatic hydrocarbons.

24. A PSA laminate according to claim 22 wherein said rubbery segments comprise polymer blocks of homopolymers or copolymers of aliphatic conjugated dienes.

25. A PSA laminate according to claim 24 wherein said rubbery segments are selected from the group consisting of polyisoprene, polybutadiene, and styrene butadiene rubbers.

26. A PSA laminate according to claim 24 wherein said rubbery segments are selected from the group consisting of polydienes and unsaturated olefin rubbers of ethylene-butylene or ethylene-propylene copolymers.

27. A PSA laminate according to claim 1 or 2 wherein said adhesive base polymer is selected from the group consisting of butadiene-based polymers, isoprene-based polymers, polyether block polyamides, and mixtures thereof.

28. A PSA laminate according to claim 27 wherein said butadiene-based polymers are selected from the group consisting of styrene-butadiene-styrene (SBS) block copolymers, styrene-butadiene (SB) block copolymers, multi-armed (SB)ₓ block copolymers, polybutadiene block copolymers, and mixtures thereof.

29. A PSA laminate according to claim 27 wherein said isoprene-based copolymers can be selected from the group consisting of styrene-isoprene-styrene (SIS) block copolymers, styrene-isoprene-butadiene-styrene (SIBS) copolymers, styrene-isoprene (SI) block copolymers, multi-armed (SI)ₓ block copolymers, radial block copolymers having an styrene-ethylene-butadiene-styrene (SEBS) backbone and isoprene and/or styrene-isoprene (SI) arms, polyisobutylene, natural rubber, synthetic polyisoprene, and mixtures thereof.

30. A PSA laminate according to claim 16 wherein di-block copolymers are selected from the group consisting of styrene-butadiene (SB), styrene-isoprene (SI), and the hydrogenated derivatives thereof.

31. A PSA laminate according to claim 16 wherein said tri-block polymers and tetra-block polymers are selected from the group consisting of styrene-butadiene-styrene (SBS), styrene-isoprene-styrene (SIS), α-methylstyrene-butadiene-α-methylstyrene, α-methylstyrene-isoprene-α-methylstyrene, styrene-isoprene-butadiene-styrene (SIBS) and derivatives thereof.

32. A PSA laminate according to claim 16 wherein said block copolymers are hydrogenated.

33. A PSA laminate according to claim 16 wherein said block copolymers are functionalized block copolymers.

34. A PSA laminate according to claim 33 wherein said functionalized block copolymer is succinic anhydride-modified SEBS.

35. A PSA laminate according to claim 1 or 2 wherein said adhesive base polymer is a high cohesive strength polymer selected from the group consisting of styrene block copolymers and isobutylene copolymers.

36. A PSA laminate according to claim 35 wherein said styrene block copolymers are selected from the group consisting of styrene-isoprene-styrene block copolymers and copolymers based on styrene and ethylene/butylene (S-E/B—S).

37. A PSA laminate according to claim 36 wherein the polystyrene content of the SIS block copolymer ranges from about 10% to about 50%.

38. A PSA laminate according to claim 35 wherein the solution viscosity of said styrene block copolymers ranges from about 0.05 Pa·s to about 20 Pa·s measured utilizing 25% solids in toluene.

39. A PSA laminate according to claim 1 or 2 wherein said adhesive base layer has a thickness ranging from about 1 μm to about 60 μm.

40. A PSA laminate according to claim 1 or 2 wherein said adhesive base layer has a thickness ranging from about 4 μm to about 40 μm.

41. A PSA laminate according to claim 1, or 2 wherein said tackifier layer further comprises at least one plasticizer.

42. A PSA laminate according to claim 1 or 2 wherein said tackifier is at least one selected from the group consisting of rosin-based and hydrogenated rosin-based tackifiers, hydrocarbon-based and hydrogenated hydrocarbon-based tackifiers, phenolic-based tackifiers, terpene-based tackifiers, terpene phenolic-based tackifiers, styrenated terpene-based tackifiers, hydrogenated terpene-based tackifiers, polyester-based tackifiers, pure monomer aromatic-based tackifiers, aromatic acrylic-based tackifiers, liquid resin type tackifiers, and functionalized type tackifiers, and mixtures thereof.

43. A PSA according to claim 41 wherein said plasticizer is at least one selected from the group consisting of naphthenic and paraffinic oils, citrates, sulfonates, and phthalates.

44. A PSA laminate according to claim 1 or 2 wherein said tackifier is soluble in said adhesive base polymer.

45. A PSA laminate according to claim 44 wherein said tackifier is soluble in polystyrene and isoprene type elastomers.

46. A PSA laminate according to claim 45 wherein said tackifier is obtained by polymerization of a stream of aliphatic petroleum derivatives in the form of dienes and mono-olefins containing 5 or 6 carbon atoms.

47. A PSA laminate according to claim 46 wherein said dienes are piperylene or isoprene.

48. A PSA laminate according to claim 1 or 2 wherein said tackifier is at least one modified C₅-type petroleum resin made by copolymerizing one or more C₅ monoolefins and/or diolefins with one or more C₈ or C₉ monoalkenyl aromatic hydrocarbons.

49. A PSA laminate according to claim 48 wherein said modified C₅-type petroleum resin is at least one selected from the group consisting of isoprene, 2-methyl-1-butene, 2-methyl-2-butene, cyclopentene, 1-pentene, cis- and trans-2-pentene, cyclopentadiene, and cis-trans-1,3-pentadiene.

50. A PSA laminate according to claim 1 or 2 wherein said tackifier is at least one hydrogenated polycyclic resins or at least one hydrogenated aromatic resin in which a substantial portion, if not all, of the benzene rings are converted to cyclohexane rings.

51. A PSA laminate according to claim 50 wherein said hydrogenated polycyclic resin is a dicyclopentadiene resin.

52. A PSA laminate according to claim 1 or 2 wherein said tackifier layer further comprises rosins, rosin esters, polyterpenes, aromatic and functionalized resins and other tackifiers that are compatible to some degree with said adhesive base polymer contained in said adhesive base layer.

53. A PSA laminate according to claim 1 or 2 wherein said tackifier layer comprises at least one tackifier in an amount of about 50% to about 90% by weight.

54. A PSA laminate according to claim 1 or 2 wherein said tackifier layer further comprises a thermoplastic elastomer which is present in the non-adhesive laminate and an amorphous resin tackifier.

55. A PSA laminate according to claim 54 wherein said tackifier layer comprises about 2% to about 15% by weight of a thermoplastic elastomer, which may be the same elastomer as present in the adhesive base layer or an elastomer compatible therewith.

56. A PSA laminate according to claim 1 or 2 wherein said tackifier layer has a thickness of about 2 μm to about 150 μm.

57. A PSA laminate according to claim 1 or 2 wherein said outer filmic layer, said adhesive base layer, and said tackifier layer of the PSA laminate further comprises inorganic fillers, and organic and inorganic additives.

58. A PSA laminate according to claim 57 wherein said inorganic fillers are selected from the group consisting of calcium carbonate, titanium dioxide, metal articles, and fibers.

59. A PSA laminate according to claim 57 wherein said additives are selected from the group consisting of flame retardants, antioxidant compounds, heat stabilizers, light stabilizers, ultra-violet light stabilizers, anti-blocking agents, processing aids, nucleating agents, and acid acceptors.

60. A PSA laminate according to claim 1 or 2 wherein said PSA laminate has a thickness of about 35 to about 400 μm.

61. A PSA laminate according to claim 60 wherein said PSA laminate has a thickness of about 50 to about 150 μm.

62. A PSA laminate according to claim 1 or 2 wherein said PSA laminate has a thickness ratio of A:B from about 50:1 to about 1:1.

63. A PSA laminate according to claim 62 wherein said PSA laminate has a thickness ratio of A:B from about 25:1 to about 2:1.

64. A non-adhesive laminate comprising:
a. at least one outer filmic layer (A) comprising at least one filmic polymer; and
b. at least one adhesive base layer (B) comprising at least one adhesive base polymer; wherein the non-adhesive laminate is obtainable by co-extruding the outer filmic layer (A) with the adhesive base layer (B) comprising at least one adhesive base polymer to produce the non-adhesive laminate.

65. A process to produce a non-adhesive laminate comprising co-extruding an outer filmic layer (A) comprising at least one filmic polymer and an adhesive base polymer layer (B) comprising at least one adhesive base polymer, wherein said non-adhesive laminate is converted into a pressure sensitive adhesive laminate by applying a tackifier layer (C).

66. A process to produce a non-adhesive laminate according to claim 65 wherein said non-adhesive laminate has a thickness of about 10 μm to about 260 μm.

67. A process to produce a non-adhesive laminate according to claim 65 wherein said non-adhesive laminate has a thickness of about 30 μm to about 80 μm.

68. A process to produce a non-adhesive laminate according to claim 65 wherein said non-adhesive laminate is uniaxially or biaxially oriented.

69. A process to produce a PSA laminate comprising co-extruding at least one outer filmic layer (A) comprising at least one filmic polymer and at least one adhesive base layer (B) comprising at least one adhesive base polymer to produce said non-adhesive laminate and applying at least one tackifier layer (C) to said adhesive base layer (B) of said non-adhesive laminate to produce said PSA laminate.

70. The process according to claim 69 wherein said non-adhesive laminate is heated prior to, subsequent to, or at the time when the tackifier is applied.

71. The process according to claim 69 wherein the tackifier is a hot melt composition, a water-based dispersion or solvent-based solution.

72. An article comprising said PSA laminate of claim 1 or 2.
